(19) United States
(12) Patent Application Publication
(10) Pub. No.: US 2019/0143356 A1
(43) Pub. Date: May 16, 2019

(54) FERTILIZER ALLOCATION SYSTEM AND FERTILIZER ALLOCATION METHOD

(71) Applicant: INSTITUTE FOR INFORMATION INDUSTRY, TAIPEI (TW)

(72) Inventors: Chien-Der LIN, Kaohsiung City (TW); Mao-Yuan CHIN, Kaohsiung City (TW); Yung-Hsing PENG, Kaohsiung City (TW); Po-Cheng HUANG, Yunlin County (TW)

(21) Appl. No.: 15/830,004

(22) Filed: Dec. 4, 2017

(30) Foreign Application Priority Data
Nov. 15, 2017 (TW) 106139532

(51) Int. Cl. B05B 12/12; B05B 12/14; A01C 15/00

(52) U.S. Cl. CPC B05B 12/122; A01C 15/005; B05B 12/1418

(57) ABSTRACT

The present invention relates to a fertilizer allocation system and fertilizer allocation method. The fertilizer allocation system includes a sprayer, a plurality of solution tanks, a camera, a processor, data storage unit and a controller. The sprayer connects to solution tanks by a flow switch and spray fertilizer, which in solution tanks to crop. The camera takes a picture of a crop and the processor compared the picture with a plurality of identification data stored on the data storage unit, then judges a growing situation of crop and generates an allocation information. The controller receives the allocation information and adjust the flow switch to change the flow of fertilizer so that crop get desired element.

### RELATED APPLICATIONS

This application claims priority to Taiwan Application Serial Number 106139532, filed Nov. 15, 2017, which is herein incorporated by reference.

### BACKGROUND

### Technical Field

The present invention relates to a fertilizer allocation system and a fertilizer allocation method. More particularly, the present invention for adjusting the flow rate of fertilizers according to the lack of fertilizer elements in the crop.

### Description of Related Art

The essential nutrient elements for plant growth, including carbon, hydrogen, oxygen, phosphorus, nitrogen, potassium, calcium, magnesium, etc. In the course of plant growth, the above elements are obtained from air, water and soil, respectively. However, air and water provide only three elements, carbon, hydrogen, and oxygen, and the other must be obtained either by soil or by artificial fertilizer. No matter how much or too little fertilizer is applied, it causes harm to plants, so the flow rate of fertilizer is very important.

In the past, farmers could only use their own experience to look at the appearance of crops (for example, the color and the shape of crop leaves) and to judge what fertilizer elements are missing in crops, then adjusted the flow rate of fertilizer to make the crop healthy and robust. However, it is easy to make mistakes in this way, resulting in poor growth of crops or wilting death, resulting in loss of farmers. Therefore, there is an urgent need for an automated, easy-to-implement and accurate judgment system to overcome.

### SUMMARY

The invention provides a fertilizer allocation system comprising a sprayer, a plurality of solution tanks, a camera, a processor and a controller. The sprayer is configured to spray fertilizer to a crop. Each solution tank stores fertilizers with different elements and be connected to the sprayer through a flow switch, respectively. The camera is configured to capture a crop image of the crop. The data storage unit is configured to store a plurality of identification data. The processor is configured to compare the crop image with the plurality of identification data to generate allocation information. The controller is configured to receive the allocation information and to drive the flow switches connected to the solution tanks according to the allocation information to adjust the flow rate of fertilizers are injected into the sprayer.

The invention also provides a fertilizer allocation system comprising a fertilizing machine and a server. The fertilizing machine comprises a sprayer, a plurality of solution tanks, a camera, a communication device and a controller. The sprayer is configured to spray fertilizer to a crop. Each solution tank stores fertilizers with different elements and is connected to the sprayer through a flow switch, respectively. The camera is configured to capture a crop image of the crop. The communication device is configured to transmit the crop image captured by the camera to the server and to receive an allocation information returned by the server. The controller is configured to drive the flow switches connected to the solution tanks according to the allocation information to adjust the flow rate of fertilizers are injected into the sprayer. Besides, the server comprises a data storage unit and a processor. The data storage unit is configured to store a plurality of identification data and a fertilizer antagonistic data, wherein each of identification data comprises a crop appearance and a fertilizer deficiency data, respectively; the fertilizer antagonistic data records an interrelated information between the fertilizers with different elements. The processor is configured to compare the crop image with the crop appearance in the identification data and to find the crop appearance most similar to the crop image and to generate the allocation information based on the corresponding fertilizer deficiency data and the fertilizer antagonistic data.

The invention further provides a fertilizer allocation method applied to a controller,which comprising the following steps: first, capturing a crop image of a crop through a camera; transmitting the crop image to a processor such that the processor compares the crop image with a plurality of identification data to generate an allocation information, then receiving the allocation information returned from the processor. Finally, driving a plurality of flow switches connected to a plurality of solution tanks according to the allocation information so that the flow switches adjust the flow rate of fertilizers are injected into a sprayer.

Through the above technical features, the fertilizer allocation system can take and analyze crop images before spraying fertilizer to identify the fertilizer elements missing in the crop, and adjust the flow rate of fertilizer mixture immediately. According to this, the adjusted fertilizer can meet the needs of crops, so as to improve the growth status of crops effectiveness.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A shows a schematic diagram of a fertilizer allocation system for one embodiment of the present invention;

FIG. 1B shows a schematic diagram of a fertilizer allocation system for another embodiment of the present invention;

FIG. 2 shows a flow chart of the steps of one of the embodiments of the present invention; and

FIG. 3 shows a schematic diagram of a fertilizer allocation system for the other embodiment of the present invention.

### DETAILED DESCRIPTION

For the embodiment below is described in detail with the accompanying drawings, embodiments are not provided to limit the scope of the present invention. Moreover, the operation of the described structure is not for limiting the order of implementation. Any device with equivalent functions that is produced from a structure formed by a recombination of elements is all covered by the scope of the invention. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

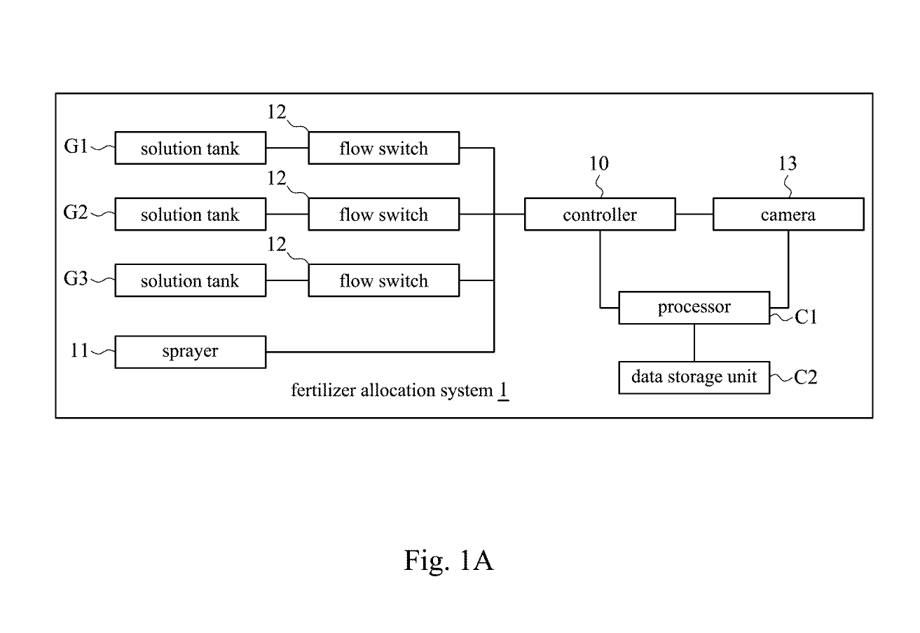

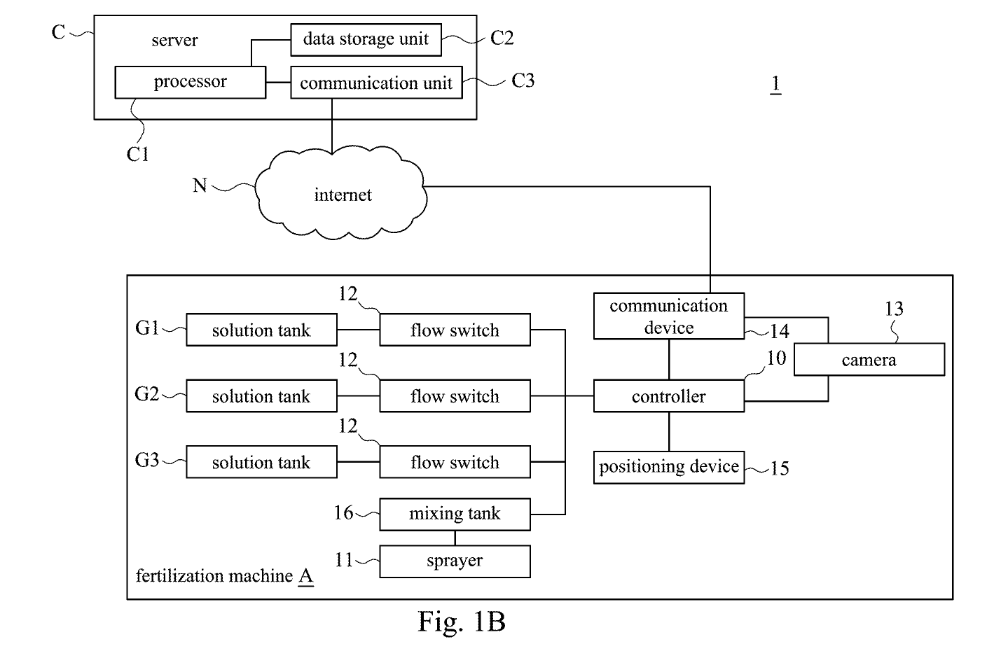

FIG. 1 shows a schematic diagram of a fertilizer allocation system for one embodiment of the present invention. The fertilizer allocation system comprising a sprayer 11, a plurality of solution tanks G1-G3, a camera 13, a data storage unit C2, a processor C1 and a controller 10. The sprayer 11 configured to spray fertilizer to a crop. Each solution tank G1-G3 stores fertilizers with different elements and be connected to the sprayer 11 through a flow switch 12 respectively. The fertilizer in the tank G1-G3 can be injected into the flow switch 12 and mixed evenly.

The camera 13 is mounted in a position adjacent to the sprayer 11 for capturing a crop image of crops, and the data storage unit C2 stores a plurality of identification data. The processor C1 compares the crop image with the plurality of identification data to generate an allocation information, which will be detailed later in the article.

The controller 10 configure to receive the allocation information and to drive the flow switches 12 connected to the solution tanks G1-G3 according to the allocation information to adjust the flow rate of fertilizers are injected into the sprayer 11. For example, each flow switch 12 may change the opening time and closing time of the injection hole on the G1-G3, or adjust the pore size of the injection hole, or the flow switch 12 may also be a combination of a flow meter and a switch.

Through the above characteristics, the fertilizer allocation system can compare the crop image with the pre-established the plurality of identification data to identify the growth state of the crop and identify the required elements in order to complete the allocation of fertilizer. For farmers, the present invention not only greatly increases identification accuracy, no threshold of use (farmers don't need to have agricultural experience) and easy to operate, therefore, it can more precisely supplement the elements that crops lack.

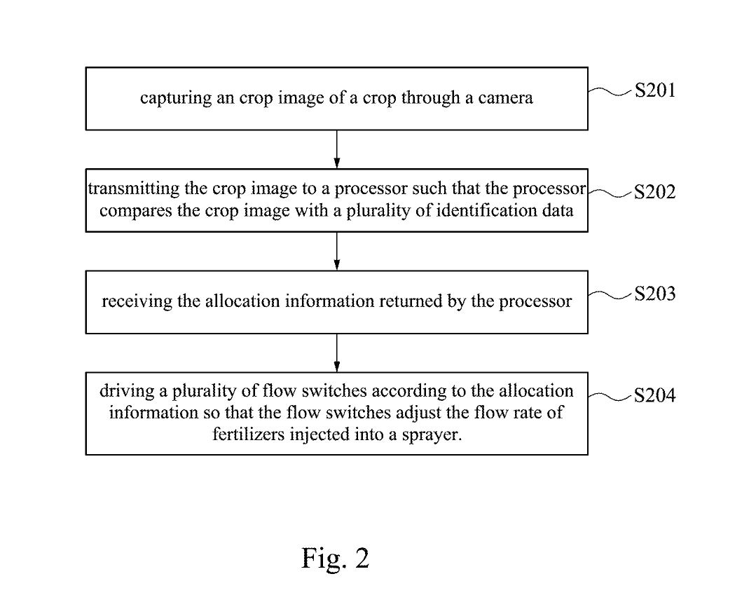

Refer to FIG. 1A and FIG. 2, wherein FIG. 2 is a flowchart of an embodiment of the present invention. The following methods are described below for the application of the fertilizer allocation system 1: First, in step S201 the fertilizer allocation system 1 retrieves crop images of crops through the camera 13. The crop can be a whole or a part of any plant, such as tomato leaves, grapefruit leaves, lemon leaves, etc.

In step S202, the camera 13 transmits the captured crop image to the processor C1 so that the processor C1 compares the crop image with the plurality of identification data to determine the fertilizer element that the crop lacks and generates an allocation information.

In step S203, the fertilizer allocation system 1 can receive the allocation information from the processor C1 through the controller 10. The allocation information may be an electrical signal (e.g. the control signal regarding the opening time and the closing time of the flow switch 12) or an instruction signal by which the command signal is restored to an electrical signal by the controller 10.

In step S204, the controller 10 drives the flow switch 12 mounted on the solution tank G1-G3 according to the allocation information, so that the flow switch 12 adjusts the flow rate of fertilizers are injected into the sprayer 11 and mixes fertilizers with a specific element ratio and spray on the crop.

In another embodiment, refer to FIG. 1B, where the identification data and a fertilizer antagonistic data are stored in the data storage unit C2. Each identification data include a crop appearance and a fertilizer deficiency data, the crop appearance is an image picture of a crop, and the fertilizer deficiency data is corresponding symptom and element information (for example, phosphorus deficiency).

The fertilizer antagonistic data record an interrelated information between the fertilizers with different elements. “Antagonism” is defined as the relative relationship between different elements that are suppressed or enhanced by each other when they are absorbed by crops at the same time. The reason for the antagonism may be that there are common transport channels and receptors of these elements in the cells, resulting in competition among the elements. For example, phosphorus and magnesium have a supportive absorption relationship, too much phosphorus will inhibit the absorption of potassium, resulting in zinc fixation, lead to zinc deficiency, hinder the absorption of copper and iron. Zinc excess can inhibit the absorption of manganese and decrease the availability of phosphorus. Any excess element in potassium, calcium, nitrogen or phosphorus all affects zinc absorption.

Magnesium and phosphorus have a strong mutual-dependent absorption, which can make plants grow vigorously, increase female flowers, and contribute to the absorption of silicon, and enhance the disease resistance of crops. Since the antagonism between the fertilizer elements is known in the field, it is not to be restated here.

The fertilizer antagonistic data can be recorded as an “antagonistic truth table” in the data storage unit C2, as follows:

| | P | Mg | K | N |
|---|---|---|---|---|
| K | −2 | −3 | 0 | +3 |
| Mg | +1 | 0 | −2 | −2 |
| Ca | +4 | +2 | −2 | −1 |
| N | +1 | +1 | −1 | 0 |

The processor C1 is electrically connected directly or indirectly with the camera 13 the controller 10 and the data storage unit C2. In the step S202, the processor C1 receives the crop image so as to be able to find a crop appearance most similar to the crop image and one of the corresponding fertilizer deficiency data based on the identification data. Then, based on the corresponding fertilizer deficiency data and the fertilizer antagonistic data, generating the allocation information.

The antagonistic truth table as described above, each element has a unique inhibition and facilitation relationship. In the case of phosphorus, for example, it can inhibit the “−2” grade of potassium, but it can promote the “+4” grade of calcium. Therefore, the processor C1 can also generate a plurality of weighted values based on the fertilizer antagonistic data, which correspond to the element of the fertilizer in each solution tank G1-G3 respectively. The controller 10 controls the opening and closing time of the corresponding flow switch 12 according to the weighted values. For example, if processor C1 is used to judge “phosphorus deficiency” in crops, the weighted values should be “potassium+2, magnesium−1, calcium−4, nitrogen−1” according to the above relationships of “potassium+2, magnesium+1, calcium+4 and nitrogen+1”. Accordingly, avoid increasing the flow rate of “phosphorus” element, but cause “potassium deficiency” or “calcium excess”.

In the other embodiment of the invention, some elements may be arranged in a server C. As shown in FIG. 1B, the sprayer 11, the solution tank G1-G3, the camera 13, the flow switch 12, and the controller 10 are all arranged on a fertilizing machine A. The fertilizing machine A still includes a communication device 14, the communication device 14 is electrically connected to the controller 10 and the camera 13, and is capable of wireless transmission and connected to the Internet N. The communication device 14 is configured to transmit the crop image captured by the camera 13 to the server C and to receive an allocation information returned by the server C.

The processor C1 and the data storage unit C2 are arranged in a server C, and the server C includes a communication unit C3. The controller 10 is electrically connected to the communication device 14 through the communication unit C3, which is configured to receive the crop images transmitted from the communication device 14 and to transmit the allocation information to the communication device 14.

In other embodiments, the fertilizer blending system 1 further includes a mixing tank 16, the mixing tank 16 is connected between the flow switches 12 and the sprayer 11 for mixing the fertilizers before the fertilizers are injected into the sprayer 11.

The fertilization machine A includes a positioning device 15 for recording a current location information of the fertilizer machine A. The positioning device 15 is electrically connected with the processor C1 through the communication device 14. After the processor C1 transmits the allocation information to the controller 10, the processor C1 can record the current location information according to the positioning device 15.

Since the fertilization machine A will pass through different areas of a farmland at different times, after multiple crop images are retrieved and the fertilizer ratio is changed multiple times according to the allocation information, the processor C1 can generate a fertilizer distribution map based on each allocation information and the current location information corresponding to the farmland. Farmers can look at the fertilization map to find out about the farmland. For example, when the fertilizer A has fertilized the entire field, the processor C1 can record the fertilization flow rate for each predetermined area (e.g. per square meter). The fertilizer distribution map was produced to enable farmers to know the distribution of fertilizer spraying on farmland (for example, nitrogen deficiency in some areas to the east of the farmland and potassium deficiency in some areas in the west).

In order to enable persons in the art to have a better understanding of the fertilizer allocation method of the present invention, the comparison method of crop images is described in detail in this paper as follows: first, when the processor C1 receives the crop image, since the crop image usually includes a large number of crops (e.g., a whole bunch of tomato leaves), the processor C1 will separate at least one leaf image from the crop image. The leaf image is then compared with the crop appearance in the identification data.

The method of leaf image separation is based on the Recurrent Instance Segmentation (ris) method published by Oxford University in 2016. It has been proved that a variety of objects can be effectively used in the separation image, and leaf separation is also the key experimental object of this method.

Before the fertilizer blending system 1 starts operation, the processor C1 must establish an image classification learning mechanism for the identification data to identify crop images uploaded by the controller 10. The image classification learning mechanism includes the well-known machine learning techniques, such as support vector machine (SVM), Neural Network . . . etc. It also includes the most popular Convolutional Neural Network network technology in recent years.

Because Convolutional Neural Network network technology can automatically extract the detail feature, it becomes the mainstream method of image classification learning with the computer computing ability becoming stronger and stronger. In the invention, the processor C1 also uses the Convolutional Neural Network network technology to study the classification of leaves in order to have the ability to recognize the image of the leaves.

In one embodiment, the processor C1 adjusts the illumination of the crop image to a predetermined value, e.g. to 500 Lux, before separating the leaf image. This predetermined value can also be set by the user himself. Besides, after the processor C1 finds an most similar crop appearance, the processor C1 stores the leaf image in the data storage unit C2 as a new crop appearance to Increase the amount of data in the data storage unit C2.

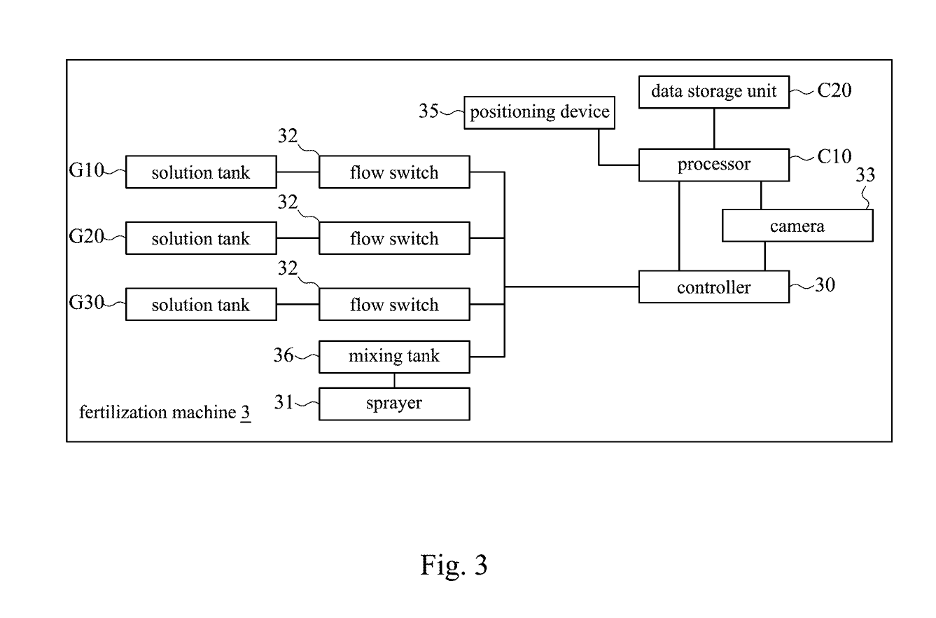

FIG. 3 is the other embodiment of the fertilizer allocation system of the present invention. The fertilizer allocation system 200 also includes a controller 30, a sprayer 31, a plurality of flow switches 32, a mixing tank 36, a plural solution tanks G10-G30, at least one camera 33, a positioning device 35, a processor C10 and a data storage unit C20. However, the functions of these elements (controller 30, sprayer 31, flow switch 32, mixing tank 36, solution tanks G10-G30, camera 33, positioning device 35, processor C10, data storage unit C20) are all similar to those of the embodiments shown in FIG. 1B and therefore are not restated herein.

Compared to the embodiment shown in the 1B diagram, In this embodiment, the sprayer 31, the solution tanks G10-G30, the camera 33, the controller 30, the mixing tank 36, the processor C10 and the data storage unit C20 are all arranged on the fertilizing machine 3. This means that the fertilizing machine 3 has the function of “server C” in FIG. 1B. Therefore, the controller 30 doesn't need to be analyzed through the internet but can be analyzed directly through the processor C10 configured on the fertilizing machine 3. As a result, it will be possible to solve the problem that some farmers in the remote agricultural land who have difficulty to use Internet services at any time.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A fertilizer allocation system comprising:
a sprayer configured to spray fertilizer to a crop;
a plurality of solution tanks, wherein each solution tank stores fertilizers with different elements and is connected to the sprayer through a flow switch, respectively;
a camera configured to capture a crop image of the crop;
a data storage unit configured to store a plurality of identification data;
a processor configured to compare the crop image with the plurality of identification data to generate allocation information; and
a controller configure to receive the allocation information and to drive the flow switches connected to the solution tanks according to the allocation information to adjust a flow rate of fertilizers injected into the sprayer.

2. The fertilizer allocation system of claim 1, wherein the data storage unit further stores a fertilizer antagonistic data, and each identification data comprises a crop appearance and a fertilizer deficiency data respectively; the fertilizer antagonistic data records an interrelated information between the fertilizers with different elements.

3. The fertilizer allocation system of claim 2, wherein the processor is connected to the camera, the controller and the data storage unit respectively, so as to receive the crop image from the camera and to compare the crop image with the crop appearance in the plurality of identification data; the processor finds the crop appearance most similar to the crop image and generates the allocation information based on the corresponding fertilizer deficiency data and the fertilizer antagonistic data.

4. The fertilizer allocation system of claim 1, wherein the allocation information comprises a plurality of weighted values, and each weighted value corresponds to the element of the fertilizer in each solution tank, such that the controller controls opening and closing times of the corresponding flow switches according to the weighted values.

5. The fertilizer allocation system of claim 1, further comprising:
a mixing tank connected between the flow switches and the sprayer for mixing the fertilizers before the fertilizers are injected into the sprayer.

6. A fertilizer allocation system comprising a fertilizing machine and a server, wherein the fertilizing machine comprises:
a sprayer configured to spray fertilizer to a crop;
a plurality of solution tanks, wherein each solution tank stores fertilizers with different elements and is connected to the sprayer through a flow switch, respectively;
a camera configured to capture a crop image of the crop;
a communication device configured to transmit the crop image captured by the camera to the server and to receive an allocation information returned from the server; and
a controller configured to drive the flow switches connected to the solution tanks according to the allocation information to adjust the flow rate of fertilizers are injected into the sprayer; and
the server comprises:
a data storage unit configured to store a plurality of identification data and a fertilizer antagonistic data, wherein each of identification data comprises a crop appearance and a fertilizer deficiency data, respectively; the fertilizer antagonistic data records an interrelated information between the fertilizers with different elements; and
a processor configured to compare the crop image with the crop appearance in the identification data and to find the crop appearance most similar to the crop image and to generate the allocation information based on the corresponding fertilizer deficiency data and the fertilizer antagonistic data.

7. The fertilizer allocation system of claim 6, wherein the fertilizing machine further comprises a positioning device connected to the processor and configured to record a current position information of the fertilizer machine; the positioning device transmits the current position information to the processor, so that the processor generates a fertilizer distribution map based on the allocation information and the current position information.

8. A fertilizer allocation method applied to a controller, comprising:
capturing a crop image of a crop through a camera;
transmitting the crop image to a processor such that the processor compares the crop image with a plurality of identification data to generate an allocation information;
receiving the allocation information returned from the processor; and
driving a plurality of flow switches connected to a plurality of solution tanks according to the allocation information so that the flow switches adjust a flow rate of fertilizers are injected into a sprayer.

9. The fertilizer allocation method of claim 8, wherein each identification data comprise a crop appearance and a fertilizer deficiency data respectively;
the processor find the crop appearance most similar to the crop image and the corresponding fertilizer deficiency data, then generates the allocation information.

10. The fertilizer allocation method of claim 9, wherein the processor connected to a data storage unit to obtain the identification data and a fertilizer antagonistic data, which records interrelated information between the fertilizers with different elements; after finding the crop appearance most similar to the crop image, the processor generates the allocation information based on the corresponding fertilizer deficiency data and the fertilizer antagonistic data.

11. The fertilizer allocation method of claim 8, wherein the allocation information comprises a plurality of weighted values, and each weighted value corresponds to the element of the fertilizer in each solution tank, such that the controller controls opening and closing times of the corresponding flow switches according to the weighted values.

12. The fertilizer allocation method of claim 9, wherein the processor separates at least one leaf image from the crop image and compares the leaf image with the crop appearance in the identification data.

13. The fertilizer allocation method of claim 12, wherein the processor adjusts the illumination of the crop image to a predetermined value before separating the image of the leaf.

14. The fertilizer allocation method of claim 13, wherein after the processor finds the crop appearance most similar to the crop image, the processor stores the leaf image in the data storage unit as a new crop appearance.

15. The fertilizer allocation method of claim 14, wherein the controller is arranged on a fertilizing machine, and the fertilizer allocation method comprises:
recording a current position information of the fertilizer machine through the positioning device, and
generating a fertilizer distribution map based on the allocation information and the current position information.

16. The fertilizer allocation method of claim 8, further comprising:
mixing the fertilizers before the fertilizers are injected into the sprayer through a mixing tank connected between the flow switches and the sprayer and configured.
